(19) United States
(12) Patent Application Publication
(10) Pub. No.: US 2015/0336288 A1
(43) Pub. Date: Nov. 26, 2015

(54) PRESSURE RELEASING CLOSURE FOR AN OIL RESERVOIR

(71) Applicant: HUSQVARNA AB, Huskvarna (SE)

(72) Inventors: Johan Hallendorff, Jönköping (SE); Joakim Persson, Skillingaryd (SE); Jonas Ingemarsson, Stockholm (SE); Jonatan Gunér, Huskvarna (SE)

(21) Appl. No.: 14/647,928

(22) PCT Filed: Nov. 28, 2012
(86) PCT No.: PCT/EP2012/073815

§ 371 Date: May 28, 2015

(51) Int. Cl. B27B 17/12; B65D 51/16; B65D 41/04

(52) U.S. Cl. CPC B27B 17/12; B65D 41/0407; B65D 51/1622

(57) ABSTRACT

A chainsaw (100) includes a power unit, a bar (120), a chain (122) operably coupled to the bar (120) to rotate around the bar (120) responsive to drive power from the power unit, an oil pump operably coupled to the power unit to deliver oil to the chain (122), an oil reservoir (150, 300, 400) and a cap (152, 200, 420). The oil reservoir (300) is configured to hold oil for delivery from the oil pump to the chain (122) and includes a fill opening (310) having a substantially circular shaped orifice in a portion of the oil reservoir (150, 300, 400). The oil cap (152, 200, 420) is configured to be securable into the fill opening (310) responsive to engagement between the oil cap (152, 200, 420) and the fill opening (310). The fill opening (310) defines an axial sealing surface (330, 460) and a radial sealing surface (340, 450). The axial sealing surface (330, 460) defines a continuous surface extending around a periphery of the fill opening (310). The radial sealing surface (340, 450) includes at least one cutout portion (350) forming a discontinuity in the radial sealing surface (340, 450 relative to a shape of the fill opening (310).

### TECHNICAL FIELD

Example embodiments generally relate to power equipment that uses oil to lubricate working components and, more particularly, relate to an oil reservoir closure that mitigates pressure build up in the oil reservoir when the closure is secured.

### BACKGROUND

A chainsaw is typically provided with an oil reservoir and an oil pump that draws oil from the oil reservoir to lubricate the chain. In many cases, the oil reservoir can be filled with oil via a fill opening that is covered by an externally visible and removable cap. Meanwhile, the oil pump draws oil from the oil reservoir via a reservoir exit. In many cases, a flexible hose may be provided to draw the oil from the oil reservoir to the oil pump. The oil pump in a fuel operated chainsaw may be driven off the clutch drum via a worm gear to supply oil through a canal that connects to a portion of the chain bar and into a groove that extends around a periphery of the chain bar. In the context of an electrically powered chainsaw, the oil pump could be driven from an output shaft of a main electric motor that is driving the chain. Alternatively, the oil pump could be driven by a separate smaller electric motor which is also powered by the battery of the product.

The chain will pick up the oil as the chain moves around the groove and this oiling of the chain generally keeps the chainsaw in good working order. However, when the chainsaw is stored for a period of time, it is not uncommon for some oil to leak, and this leakage can stain surfaces or concern operators that there is a problem with the lubrication system. Although these reactions are understandable, the phenomena can occur without any fault existing in the chainsaw. Instead, since the oil pump is generally not engineered to be 100% free of leakage, any air that is in the oil reservoir can tend to expand and contract with changes in temperature. Accordingly, if the air that is in the tank expands due to heating of the storage environment over the course of a day, the oil in the oil reservoir may essentially be pushed or pumped through the oil pump and into the canal mentioned above. This oil may then drip out, even though the chainsaw is otherwise in normal working condition.

To prevent leakage of the oil past the removable cap, the cap will typically include a gasket that extends around the cap to engage a periphery of the fill opening when the cap is secured into the fill opening. When the gasket forms a seal with the fill opening, there may often be some axial movement of the cap inwardly to secure the cap to the fill opening. This inward movement of the cap may pressurize the air in the oil reservoir above atmospheric pressure. The increase in pressure in the oil reservoir may then exacerbate the issue of oil leakage through the oil pump due to temperature changes.

Accordingly, there may be a need for an arrangement providing for chain oiling that may at least reduce the likelihood of having oil escape from the oil reservoir.

### BRIEF SUMMARY OF SOME EXAMPLES

Some example embodiments may therefore provide an oil assembly for oiling a working component that includes an oil reservoir and an oil cap. The oil reservoir may be provided with a fill opening that has an axial and radial sealing surface. A gasket associated with the oil cap may be drawn into the fill opening to eventually seal against the axial sealing surface. However, as the oil cap is being drawn in, pressure may be enabled to exit the oil reservoir over a discontinuity or cutout portion provided in the radial sealing surface. Accordingly, the amount of oil pressure increase that might otherwise occur as the oil cap is drawn into secured contact with the fill opening may be reduced.

In one example embodiment, a chainsaw is provided. The chainsaw may include a power unit, a bar, a chain operably coupled to the bar to rotate around the bar responsive to drive power from the power unit, an oil pump operably coupled to the power unit to deliver oil to the chain, an oil reservoir and a cap. The oil reservoir may be configured to hold oil for delivery from the oil pump to the chain and includes a fill opening having a substantially circular shaped orifice in a portion of the oil reservoir. The oil cap is configured to be securable into the fill opening responsive to engagement between the oil cap and the fill opening. The fill opening may define an axial sealing surface and a radial sealing surface. The axial sealing surface may define a continuous surface extending around a periphery of the fill opening. The radial sealing surface may include at least one cutout portion forming a discontinuity in the radial sealing surface relative to a shape of the fill opening.

In another example embodiment, a chainsaw oil reservoir is provided. The oil reservoir may provide chain oil to an oil pump of a chainsaw. The oil reservoir may be configured to hold oil for delivery from the oil pump to the chain and includes a fill opening having a substantially circular shaped orifice in a portion of the oil reservoir. The oil cap is configured to be securable into the fill opening responsive to engagement between the oil cap and the fill opening. The fill opening may define an axial sealing surface and a radial sealing surface. The axial sealing surface may define a continuous surface extending around a periphery of the fill opening. The radial sealing surface may include at least one cutout portion forming a discontinuity in the radial sealing surface relative to a shape of the fill opening.

Some example embodiments may provide a way to reduce the likelihood of experiencing any oil leakage after filling of an oil reservoir of power equipment such as, for example, a chainsaw.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a chainsaw according to an example embodiment;

FIG. 2 illustrates a side view of a cap for an oil reservoir according to an example embodiment;

FIG. 3 illustrates a conceptual view of an oil reservoir in accordance with an example embodiment;

FIG. 4A illustrates a top view of an oil reservoir having multiple cutout portions disposed in a radial sealing surface thereof according to an example embodiment;

FIG. 4B illustrates a top perspective view of an example oval shape for the radial sealing surface with the cap removed according to an example embodiment;

FIG. 4C illustrates a top view of the oval shaped radial sealing surface with the cap installed according to an example embodiment;

FIG. 5A illustrates a side view of an oil reservoir according to an example embodiment;

FIG. 5B illustrates a cross section view of the oil reservoir of FIG. 5A along line A-A where the cross section passes through cutouts positioned on opposing sides of the fill opening according to an example embodiment;

FIG. 6A illustrates a side view of the oil reservoir rotated by approximately 45 degrees according to an example embodiment; and

FIG. 6B illustrates a cross section view of the oil reservoir along line B-B of FIG. 6A, where the cross section passes through a portion of the fill opening at which no cutouts are located according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein provide an oil reservoir for power tools that is designed to mitigate oil leakage through the oil pump that may occur due to environmental temperature changes while the power tool is stored. In this regard, the oil reservoir of an example embodiment may be designed in order to mitigate pressure increases that may occur due to closure of the cap on the oil reservoir by allowing pressure to escape past the cap while it is being affixed to the oil reservoir. By reducing the initial pressure in the oil reservoir, any affects associated with pressure changes that might occur due to temperature changes in the environment may also be reduced. In an example embodiment, the oil reservoir may be provided with axial and radial sealing surfaces that are configured such that the radial sealing surface includes a cutout portion or discontinuity in the surface thereof. The cutout portion may enable pressure to escape the oil reservoir past the radial sealing surface until the axial sealing surface is fully engaged to seal the oil reservoir.

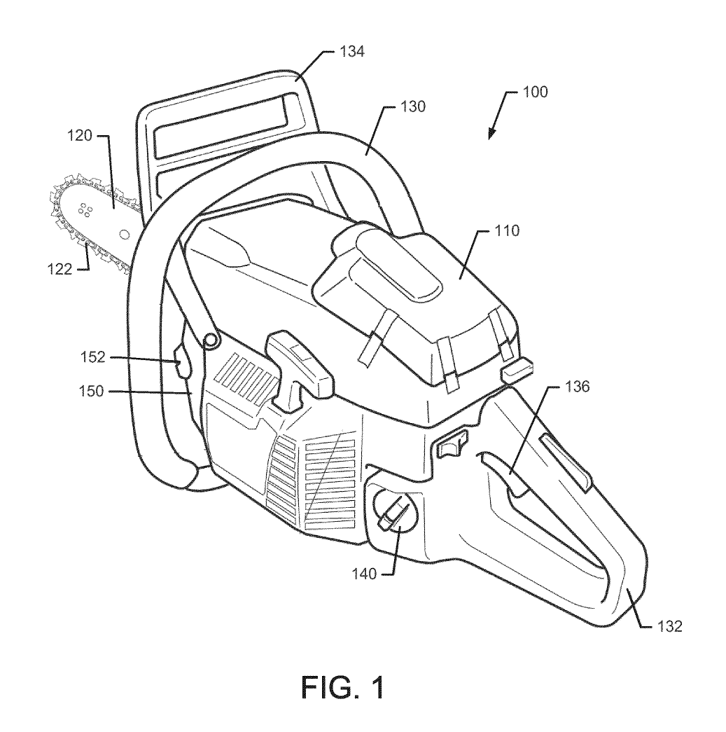

FIG. 1 illustrates a perspective view of a chainsaw 100 according to an example embodiment. It should be appreciated that although an example embodiment is shown and described illustrating a hand held chainsaw, example embodiments could be practiced in connection with other similar devices such as pole saws or other cutting devices that employ a chain that rotates to affect cutting, where it is advantageous to lubricate the chain for better performance. It should also be appreciated that the chainsaw 100 is merely one example of power equipment that includes a working assembly (i.e., the cutting components of the chainsaw 100) that may require or otherwise benefit from oiling of the components thereof. Thus, example embodiments could also be practiced in connection with some other power equipment that may include an oil reservoir.

As shown in FIG. 1, the chainsaw 100 may include a housing 110 inside which a power unit or motor (not shown) is housed. In some embodiments, the power unit may be either an electric motor or an internal combustion engine. Furthermore, in some embodiments, the power unit may include more than one electric motor where one such electric motor powers the working assembly of the chainsaw 100 and the other electric motor of the power unit powers a pump that lubricates the working assembly. The chainsaw 100 may further include a guide bar 120 that is attached to housing 110 along one side thereof. A chain 122 may be driven around the guide bar 120 responsive to operation of the power unit in order to enable the chainsaw 100 to cut lumber or other materials. The guide bar 120 and the chain 122 may form the working assembly of the chainsaw 100.

The chainsaw 100 may include a front handle 130 and a rear handle 132. A chain brake and front hand guard 134 may be positioned forward of the front handle 130 to stop the movement of the chain 122 in the event of a kickback. The rear handle 132 may include a trigger 136 to facilitate control of the power unit. The housing 110 may include a fuel tank for providing fuel to the motor and a fuel tank cap 140 may provide access to the fuel tank. The housing 110 may also include or at least partially define an oil reservoir 150, access to which may be provided by an oil tank cap 152.

The oil tank cap 152 may be removed to allow the operator to pour oil into the oil reservoir 150. The oil in the oil reservoir 150 may be used to oil the chain 122 as described above. In this regard, an oil pump (not shown) may draw oil from the oil reservoir 150 and deliver the oil to the chain 122 via openings in the guide bar 120. The oil pump may be operably coupled to the power unit to receive power therefrom. In embodiments in which the power unit is one or more electric motors, the operable coupling may be relatively direct insofar as the oil pump may operate whenever the power unit is running (since the chain will also be moving responsive to at least one of the electric motors of the power unit running). However, in embodiments in which the power unit is a gasoline engine, the oil pump may be indirectly and/or selectively coupled to the power unit. In this regard, when the power unit is idling, there is no need for the oil pump to dispense oil, since the chain 122 is not turning. However, when the chain 122 is turning, it is desirable to dispense oil. Thus, for example, the oil pump may be operably coupled to the power unit via a centrifugal clutch so that when the power unit is running at a speed above engagement rpm of the centrifugal clutch and the clutch engages the chain 122 to turn, the oil pump will also be operated to dispense oil.

In some embodiments, the oil reservoir 150 may extend substantially from one side of the housing 110 to the other (e.g., from the left side to the right side) across a front portion of the chainsaw 100. As shown in FIG. 1, the oil may be inserted on one side (e.g., the left side of the chainsaw 100) and may be dispensed to the chain 122 on the other side (e.g., the right side) of the chainsaw 100. In the context of the present application, the terms right and left side of the chainsaw 100 should be understood to be referenced relative to a “normal orientation” of the chainsaw 100 in which the longitudinal length of the chainsaw 100 extends substantially parallel to a ground plane from the rear handle 132 to the end of the guide bar 120. In the normal orientation, the end of the guide bar 120 is considered the front of the chainsaw 100, with the plane in which the guide bar 120 lies being substantially perpendicular to the ground plane. In this orientation, the chainsaw 100 of FIG. 1 sits on its bottom and has the guide bar 120 on the right side and the oil tank cap 152 is on the left side of the chainsaw 100. Meanwhile, the chain brake and front hand guard 134 extends over the top of the chainsaw 100.

In some embodiments, the oil reservoir 150 may be provided with fill opening (not visible in FIG. 1 due to the presence of the oil tank cap 152) that is configured to allow oil to be poured or otherwise provided into the oil reservoir 150. The oil tank cap 152 may be configured to engage the fill opening to enclose the oil reservoir 150 and prevent leakage of oil out of the oil reservoir 150 through the fill opening.

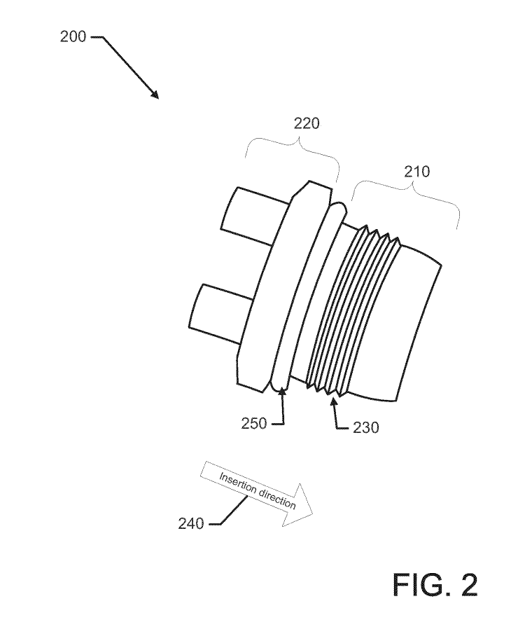

FIG. 2 illustrates a side view of a cap 200 according to an example embodiment. The cap 200 of FIG. 2 may be an example of the oil tank cap 152 shown in FIG. 1. However, it should be appreciated that the cap 200 of FIG. 2 is merely an example and other specific structures could be substituted in some embodiments. Thus, for example, the size, shape, arrangement and/or spacing of various components of the cap 200 could be modified in some cases. Furthermore, additional or fewer components may be employed in some embodiments.

As shown in FIG. 2, the cap 200 may include an insertion portion 210 and a cover portion 220. The insertion portion 210 may be inserted into the fill opening when the cap 200 is secured thereto, while the cover portion 220 may remain outside the fill opening. In an example embodiment, the insertion portion 210 may include a threaded portion 230, which may form an engagement assembly with corresponding threads of the fill opening. Accordingly, when the threaded portion 230 of the cap 200 is engaged with the corresponding threads of the fill opening and the cap is turned in the tightening direction (e.g., clockwise), the insertion portion 210 is drawn farther into the fill opening (i.e., in the insertion direction 240).

The insertion portion 210 may be substantially cylindrical in shape with a longitudinal axis of the insertion portion 210 forming the axial centerline of the cylinder. The axial sidewalls of the insertion portion 210 may extend substantially parallel to the insertion direction 240 when the cap 200 is inserted into the fill opening. Accordingly, the threads of the threaded portion 230 may extend (in a continuous or discontinuous fashion) around a periphery of the insertion portion 210 extending radially outwardly from the axial sidewalls of the insertion portion 210.

In an example embodiment, a gasket 250 may be provided onto the cap 200 proximate to an intersection of the cover portion 220 and the insertion portion 210. The gasket 250 may be made of rubber or some other flexible material that is suitable for providing sealing functionality when compressed between two surfaces. The gasket 250 may be annular in shape to form an O-ring that is insertable over the insertion portion 210 to sit against a bottom surface of the cover portion 220 (i.e., the surface that faces the casing 110 of the chainsaw 100). As the engagement assembly operates to secure the cap 200 to the fill opening, the cover portion 220 may be drawn in the insertion direction 240 and the gasket 250 may be compressed between the cover portion 220 and/or the insertion portion 210 and the corresponding sealing surfaces of the fill opening to prevent leakage of oil out of the oil reservoir (e.g., oil reservoir 150) between the cap 200 and the fill opening.

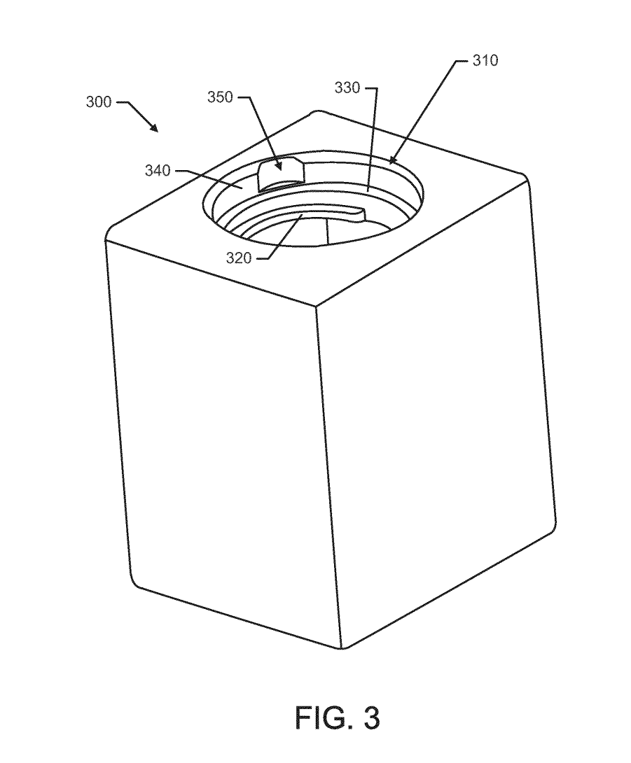

FIG. 3 illustrates a conceptual view of an oil reservoir 300 (of which oil reservoir 150 may be an example). As shown in FIG. 3, the oil reservoir 300 may form a container in which oil may be stored. The oil may be provided into the oil reservoir 300 via a fill opening 310. The fill opening 310 may be a circular shaped orifice or opening formed in a portion of the oil reservoir 300 (e.g., in one of the walls thereof). The fill opening 310 may defined by sidewalls that extend from an interior of the oil reservoir 300 to an outer surface of the oil reservoir. The sidewalls may include a thread portion 320 that, together with the threaded portion 230 of the cap 200 form the engagement assembly to enable securing of the cap 200 to the fill opening 310. The sidewalls may also include an axial sealing surface 330 and a radial sealing surface 340 that may provide for sealing of the fill opening 310 responsive to insertion of the cap 200 therein, and securing of the cap 200 to the point of compressing the gasket 250 between the cap 200 and the axial and/or radial sealing surfaces 330 and 340. The axial sealing surface 330 may form a sealing surface substantially in an axial direction (e.g., substantially parallel to the direction of insertion 240), and the radial sealing surface 340 may form a sealing surface substantially in a radial direction (e.g., substantially perpendicular to the direction of insertion 240).

In an example embodiment, the axial sealing surface 330 may be formed as a continuous surface extending around a periphery of the fill opening. In some embodiments, the axial sealing surface 330 may lie entirely in a plane that is substantially perpendicular to the axis of the fill opening 310. However, in other embodiments, the axial sealing surface 330 may be sloped inwardly. The inward sloping may cause the shape of the axial sealing surface 330 to define sidewalls of a conical frustum. However, in some cases, the axial sealing surface 330 may be curved while progressing transversely across the axial sealing surface 330. Because the axial sealing surface 330 is a continuous surface as it extends around the periphery of the fill opening 310, the axial sealing surface 330 may form a substantially leak-proof seal with the gasket 250 when the gasket 250 is compressed between the cap 200 and the axial sealing surface 330.

In an example embodiment, the axial sealing surface 330 may be disposed between the radial sealing surface 340 and the thread portion 320. The radial sealing surface 340 may include at least one cutout portion 350 forming a discontinuity in the radial sealing surface 340 relative to matching the shape of the periphery of the gasket 250. As such, the radial sealing surface 340 may be arranged to extend around the periphery of the fill opening 310 and be substantially continuous with the exception of the cutout portion 350 (or multiple cutout portions) which extend away from the fill opening 310. Thus, it should be appreciated that the term “discontinuity” refers to an interruption relative to matching of the annular shape of the gasket 250 and does not necessarily infer that there are sharp edges or corners involved in forming the discontinuity. In some embodiments, the gasket 250 may engage at least a portion of the radial sealing surface 340 as the cap 200 is secured to the fill opening 310 by movement of the cap 200 into the fill opening 310 in the direction of insertion 240. As such, the gasket 250 may ride along at least a portion of the radial sealing surface 340 and be in contact therewith as the cap 200 is drawn into the fill opening 310 via the tightening of the engagement assembly until the gasket 250 is compressed when the engagement assembly is tightened. In an example embodiment, the contact between the gasket 250 and the radial sealing surface 340 may extend continuously around the radial sealing surface 340 except where the cutout portion 350 is provided. As such, an external periphery of the gasket 250 may move along the radial sealing surface 340 from one axial end of the fill opening 310 (i.e., the outer axial end relative to the interior of the oil reservoir 300) inwardly in an axial direction until the gasket 250 is compressed between the cap 200 and the axial sealing surface 330. The radial sealing surface 340 may provide an air tight seal with the gasket 250 along all portions of the radial sealing surface 340 except that air may be enabled to pass over the radial sealing surface 340 at the cutout portion 350. The cutout portion 350 may therefore provide a pressure relief path for air that would otherwise be compressed in the oil reservoir 300 responsive to the cap 200 being drawn into the fill opening 310 without enabling air to escape via the cutout portion 350.

In an example embodiment, as shown in FIG. 3, the cutout portion 350 may extend substantially parallel to the axis of the fill opening 310. In some cases, the cutout portion 350 may extend transversely across the radial sealing surface 340 from the opposite axial end of the fill opening to a point on the radial sealing surface 340 that is proximate to the axial sealing surface 330. In some embodiments, the cutout portion 350 may extend transversely across the entirety of the radial sealing surface 340, while in other embodiments, the cutout portion 350 may extend across a majority portion of the transverse direction of the radial sealing surface 340, but may terminate before the axial sealing surface 330 is reached. Thus, it is possible that in some embodiments the radial sealing surface 340 may not be enabled to effectively provide a radial seal due to the existence of a cutout portion extending transversely over an entirety of the radial sealing surface 340. However, in embodiments where the cutout portion 350 does not extend transversely across the entirety of the radial sealing surface 340, the radial periphery of the gasket 250 may provide a substantially leak proof seal when engaged with the portion of the radial sealing surface 340 that does not include any cutout portion 350. Thus, in such an embodiment, both the radial sealing surface 340 and the axial sealing surface 330 may each provide substantially leak proof seals by engagement with the gasket 250.

In some cases, the axial and radial sealing surfaces 330 and 340 may be disposed to be adjacent to each other and substantially perpendicular to each other. However, as indicated above, if the axial sealing surface 330 is angled inwardly, the angle formed between the axial and radial sealing surfaces 330 and 340 may be obtuse. Moreover, in some embodiments, there may be a curved transition between the axial and radial sealing surfaces 330 and 340 and the curved transition may be similar in shape to the corresponding shape of the gasket 250. In still other cases, the cutout portion 350 may not extend transversely across the radial sealing surface 340, but may extend substantially perpendicular to a portion of the radial sealing surface 340. In other words, the cutout portion 350 may form a channel that extends away from the fill opening 310 (e.g., radially outwardly) to allow air in the oil reservoir 300 to escape therefrom as the cap 200 is tightened. In some cases, the air may be enabled to escape until the axial sealing surface 330 engages the gasket 250. Thus, for example, a channel-like embodiment of the cutout portion 350 may provide for a channel of any size that extends away from the fill opening through a portion of the radial sealing surface 340 proximate to the axial sealing surface such that the channel forms the discontinuity in the radial sealing surface 340. As such, for example, portions of the radial sealing surface 340 above and/or below the channel may extend continuously around the fill opening 310 such that a periphery of the gasket 250 (with or without a sealing lip) may engage these continuous portions during installation of the cap 200 into the fill opening 310. However, the discontinuity in the radial sealing surface 340 formed by the channel-like cutout portion may enable air to escape the oil reservoir 300 while tightening of the cap 200 is in progress.

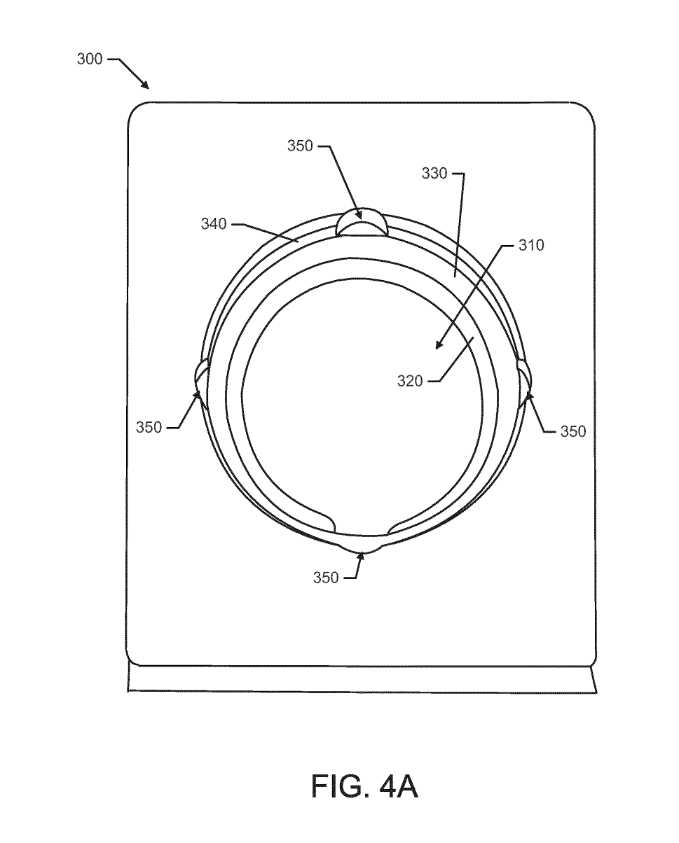

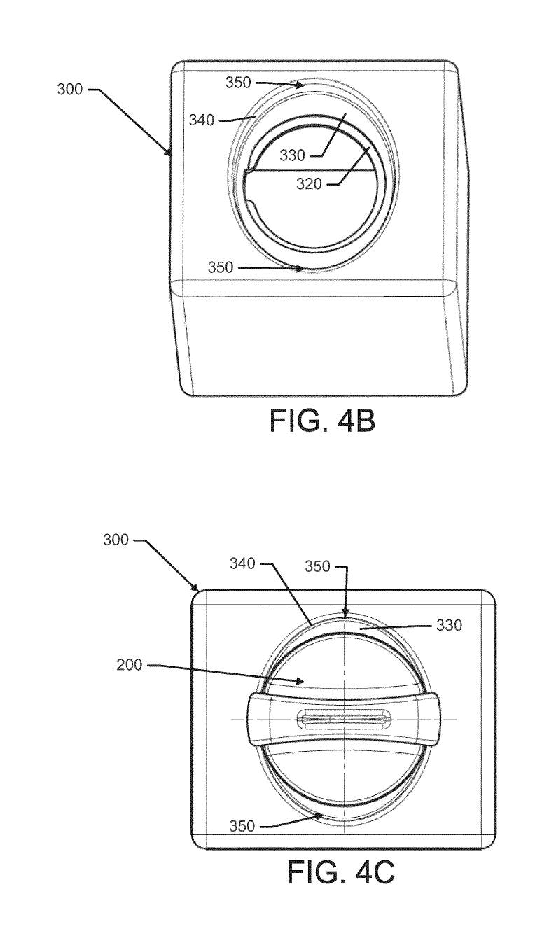

In some embodiments, multiple cutouts 350 may be employed. FIG. 4A illustrates such an example. To facilitate equalization of pressure relief in an embodiment that employs multiple cutouts 350, the cutouts may be dispersed to be equidistant from each other around the periphery of the fill opening 310 along the radial sealing surface 340. In some cases, reduction in pressure increase that would otherwise occur when the air in the oil reservoir is compressed by sealing the cap 200 onto the fill opening 310 may be as much as a factor of 10. However, more or less pressure reduction may be provided in alternative embodiments.

In an example embodiment, the cutout portions 350 could take any desirable shape. Although FIG. 3 and FIG. 4A illustrate relatively small arcuate shaped cutouts, the cutout portion 350 could instead be triangular, rectangular, or any other suitable shape. When multiple cutouts are employed, the overall shape of the radial sealing surface 340 may take the form of a square, pentagon, hexagon, octagon, or an oval. Irregular polygons or other irregular shapes could also be employed. FIG. 4B illustrates a top perspective view of one example shape (e.g., an oval shape) for the radial sealing surface 340 with the cap 200 removed according to an example embodiment. Meanwhile, FIG. 4C illustrates a top view of the radial sealing surface 340 (formed via discontinuities that define cutout portions 350 that generate an oval shape) with the cap 200 installed according to an example embodiment.

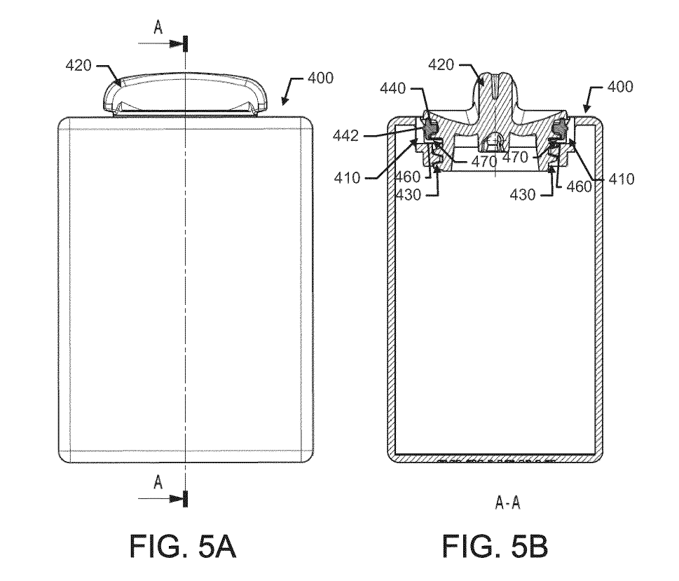

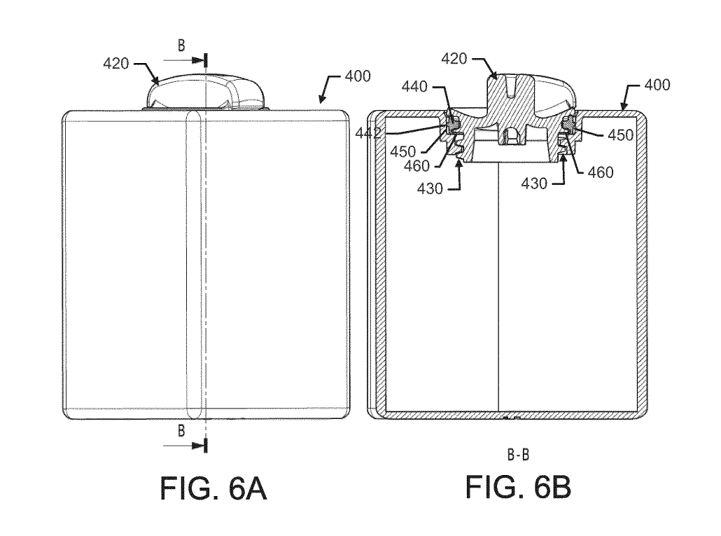

FIGS. 5 and 6 illustrate an alternative example of an oil reservoir to further illustrate an example embodiment. In this regard, FIG. 5A illustrates a side view of an oil reservoir 400 according to an example embodiment and FIG. 5B illustrates a cross section view of the oil reservoir 400 along line A-A of FIG. 5A where the cross section passes through cutouts 410 positioned on opposing sides of the fill opening. Meanwhile FIG. 6A illustrates a side view of the oil reservoir 400 rotated by approximately 45 degrees according to an example embodiment and FIG. 6B illustrates a cross section view of the oil reservoir 400 along line B-B of FIG. 6A where the cross section passes through a portion of the fill opening at which no cutouts 410 are located.

As shown in FIGS. 5A and 5B, the cap 420 is disposed within the fill opening with the thread assembly 430 engaged. A gasket 440 is provided on a portion of the cap 420 that faces a radial sealing surface 450 and an axial sealing surface 460 while the thread assembly 430 is tightened to draw the cap 420 further into the fill opening. In this example, the gasket 440 includes a sealing lip 442 that may extend around the outer periphery of the gasket 440. The sealing lip 442 extends toward the radial sealing surface 450 and contacts the radial sealing surface (see FIG. 6) except where the cutouts 410 are positioned (as shown in FIG. 5B). As the thread assembly 430 is tightened, air can escape between the axial sealing surface 460 and the gasket 440 through a gap 470 therebetween, and through the cutouts 410 until the cap 420 is finally tightened (e.g., until the axial sealing surface 460 engages the gasket 440). This mitigates or minimizes the pressure build up in the oil reservoir 400 as described above.

As the thread assembly 430 is tightened, the gasket 440 may come into contact with the axial sealing surface 460 as shown in FIG. 6B. As the gasket 440 comes into contact with the axial sealing surface 460, the gasket 440 may be slightly compressed between the cap 420 and the axial sealing surface 460 to define a tight and substantially leak proof seal therebetween. The gap 470 of FIG. 5B is no longer maintained between the gasket 440 and the axial sealing surface 460. Meanwhile, as shown in FIG. 6B, the sealing lip 442 may facilitate engagement between the radial sealing surface 450 and the gasket 440 (again, except where the cutouts 410 are positioned). In some cases, the sealing lip 442 may facilitate stabilization of the cap 420 to prevent loosening of the cap 420 by vibrations during operation of the chainsaw 100.

Thus, by reducing the initial pressure in the oil reservoir that is built up responsive to compression of the air in the oil reservoir during capping of the oil reservoir, it may be possible to avoid or at least mitigate the possibility of oil being pushed through the oil pump due to environmental temperature changes (and therefore corresponding pressure changes within the fixed volume defined by the oil reservoir).

In an example embodiment, a chainsaw is provided. The chainsaw may include a power unit, a bar, a chain operably coupled to the bar to rotate around the bar responsive to drive power from the power unit, an oil pump operably coupled to the power unit to deliver oil to the chain, an oil reservoir and a cap. The oil reservoir may be configured to hold oil for delivery from the oil pump to the chain and includes a fill opening having a substantially circular shaped orifice in a portion of the oil reservoir. The oil cap is configured to be securable into the fill opening responsive to engagement between the oil cap and the fill opening. The fill opening may define an axial sealing surface and a radial sealing surface. The axial sealing surface may define a continuous surface extending around a periphery of the fill opening. The radial sealing surface may include at least one cutout portion forming a discontinuity in the radial sealing surface relative to a shape of the fill opening.

The chainsaw (or oil chamber) of some embodiments may include additional features that may be optionally added either alone or in combination with each other. For example, in some embodiments, (1) the at least one cutout portion defines an air path for pressure relief past the radial sealing surface responsive to movement of the oil cap toward a secured position at which a gasket of the oil cap engages the axial sealing surface. Additionally or alternatively, (2) the oil cap and the fill opening engage each other via a thread assembly and the threads of the fill opening are disposed proximate to one axial end of the fill opening and the radial sealing surface extends toward the threads from an opposite axial end of the fill opening. In some cases, (3) the at least one cutout portion extends substantially parallel to the axis of the fill opening. Additionally or alternatively, (4) the at least one cutout portion extends transversely across the radial sealing surface from the opposite axial end of the fill opening to a point on the radial sealing surface that is proximate to the axial sealing surface.

In some embodiments, any or all of (1) to (4) may be employed, and the axial sealing surface lies in a plane substantially perpendicular to an axis of the fill opening. In an example embodiment, any or all of (1) to (4) may be employed, and the radial sealing surface extends around the periphery of the fill opening substantially parallel to an axis of the fill opening. In some embodiments, any or all of (1) to (4) may be employed, and the axial and radial sealing surfaces are adjacent to each other and substantially perpendicular to each other. Additionally or alternatively, the at least one cutout portion comprises a plurality of cutouts positioned equidistant from each other on the radial sealing surface. In some embodiments, any or all of (1) to (4) may be employed, and the axial sealing surface has a shape defining sidewalls of a conical frustum.

Accordingly, some example embodiment may provide a relatively reliable mechanism by which to control pressure in an oil reservoir to prevent or at least reduce oil leakage through the oil pump. Moreover, in some cases, example embodiments can be used in connection without modifying existing caps. Thus, an old cap can be used in connection with an oil tank having cutouts in the fill opening to mitigate pressure build up without any modification being required for the cap.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A tank for a power tool, the tank for containing one of oil/lubricant or petrol, the tank comprising:
a reservoir configured to hold liquid, the reservoir including a fill opening comprising a substantially circular shaped orifice in a portion of the reservoir defining a radial sealing surface; and
a cap configured to be securable into the fill opening responsive to engagement between the cap and the fill opening,
wherein the fill opening further defines an axial sealing surface, the axial sealing surface defining a continuous surface extending around a periphery of the fill opening, and in that the radial sealing surface including at least one cutout portion forming a discontinuity in the radial sealing surface relative to a shape of the fill opening.

2. The tank of claim 1, wherein the at least one cutout portion defines an air path for pressure relief past the radial sealing surface responsive to movement of the cap toward a secured position at which a gasket of the cap engages the axial sealing surface.

3. The tank of claim 1, wherein the cap and the fill opening engage each other via a thread assembly and wherein threads of the fill opening are disposed proximate to one axial end of the fill opening and the radial sealing surface extends toward the threads from an opposite axial end of the fill opening.

4. The tank of claim 3, wherein the at least one cutout portion extends substantially parallel to the axis of the fill opening.

5. The tank of claim 3, wherein the at least one cutout portion extends transversely across the radial sealing surface from the opposite axial end of the fill opening to a point on the radial sealing surface that is proximate to the axial sealing surface.

6. The tank of claim 1, wherein the axial sealing surface lies in a plane substantially perpendicular to an axis of the fill opening.

7. The tank of claim 1, wherein the radial sealing surface extends around the periphery of the fill opening substantially parallel to an axis of the fill opening.

8. The tank of claim 1, wherein the axial and radial sealing surfaces are adjacent to each other and substantially perpendicular to each other.

9. The tank of claim 1, wherein the at least one cutout portion comprises a plurality of cutouts positioned equidistant from each other on the radial sealing surface.

10. The tank of claim 1, wherein the axial sealing surface has a shape defining sidewalls of a conical frustum.

11. The tank of claim 1, wherein a gasket is provided onto the cap on a portion of the cap that faces the radial sealing surface and the axial sealing surface.

12. A power tool comprising:
a power unit;
a bar;
a chain operably coupled to the bar to rotate around the bar responsive to drive power from the power unit; and
a tank for providing oil/lubricant to the chain, the tank comprising:
a reservoir configured to hold the oil/lubricant, the reservoir including a fill opening comprising a substantially circular shaped orifice in a portion of the reservoir defining a radial sealing surface; and
a cap configured to be securable into the fill opening responsive to engagement between the cap and the fill opening,
wherein the fill opening further defines an axial sealing surface, the axial sealing surface defining a continuous surface extending around a periphery of the fill opening, and in that the radial sealing surface including at least one cutout portion forming a discontinuity in the radial sealing surface relative to a shape of the fill opening.

13. The power tool of claim 12, wherein the at least one cutout portion defines an air path for pressure relief past the radial sealing surface responsive to movement of the cap toward a secured position at which a gasket of the cap engages the axial sealing surface.

14. The power tool of claim 12, wherein the cap and the fill opening engage each other via a thread assembly and wherein threads of the fill opening are disposed proximate to one axial end of the fill opening and the radial sealing surface extends toward the threads from an opposite axial end of the fill opening.

15. The power tool of claim 14, wherein the at least one cutout portion extends substantially parallel to the axis of the fill opening.

16. The power tool of claim 14, wherein the at least one cutout portion extends transversely across the radial sealing surface from the opposite axial end of the fill opening to a point on the radial sealing surface that is proximate to the axial sealing surface.

17. The power tool of claim 12, wherein the axial sealing surface lies in a plane substantially perpendicular to an axis of the fill opening.

18. The power tool of claim 12, wherein the radial sealing surface extends around the periphery of the fill opening substantially parallel to an axis of the fill opening.

19. The power tool of claim 12, wherein the axial and radial sealing surfaces are adjacent to each other and substantially perpendicular to each other.

20. The power tool of claim 12, wherein the at least one cutout portion comprises a plurality of cutouts positioned equidistant from each other on the radial sealing surface.

21. The power tool of claim 12, wherein the axial sealing surface has a shape defining sidewalls of a conical frustum.

22. The power tool according to claim 12, wherein the power tool is one of a chainsaw, a pole saw and the other cutting devices employing the chain to affect cutting.

23. The power tool according to claim 12, wherein the power unit is one of an electric motor and an internal combustion engine.
